(19) United States
(12) Patent Application Publication
(10) Pub. No.: US 2023/0382561 A1
(43) Pub. Date: Nov. 30, 2023

(54) MANUFACTURING METHOD OF A STIFFENED PANEL WITH OPEN-SECTION STRINGERS FOR AERONAUTICAL APPLICATION

(71) Applicant: LEONARDO S.P.A., Roma (IT)

(72) Inventors: Gianni IAGULLI, Foggia (IT); Giuseppe TOTARO, Lucera (Foggia) (IT); Marco RAFFONE, Napoli (IT); Michele FRASCA, Foggia (IT)

(21) Appl. No.: 18/034,112

(22) PCT Filed: Oct. 27, 2021
(86) PCT No.: PCT/IB2021/059915

§ 371 Date: Apr. 27, 2023

(30) Foreign Application Priority Data
Oct. 28, 2020 (IT) 102020000025525

(51) Int. Cl. B64F 5/10; B64C 1/06; B29C 70/54; B29C 70/76; B29C 70/38; B29C 70/44

(52) U.S. Cl. CPC B64F 5/10; B64C 1/064; B29C 70/545; B29C 70/543; B29C 70/763; B29C 70/38; B29C 70/44; B29L 2031/3076

(57) ABSTRACT

A method for manufacturing a panel for an aircraft is provided. The method includes arranging, on a curing surface, a skin of pre-preg composite material, arranging a plurality of pre-formed, uncured composite stringers, each having an open cross section with a web and a base transverse to each other so that a first base portion protrudes toward a first side and a second base portion protrudes toward a second side, arranging the stringers on the skin with the base in contact with the skin, arranging, on each stringer, a respective first mandrel to completely cover the first base portion and a respective second mandrel to completely cover the second base portion, and having the skin and the stringers undergo a co-curing process in autoclave with vacuum bag.

### TECHNICAL FIELD

This invention relates to a method for manufacturing a structural component for aircraft, specifically a panel stiffened with open-section composite stringers.

### PRIOR ART

Currently these panels are made in autoclave, gluing together components already polymerized or solidified (typically, the stringers) with others still in the fresh state or non-polymerized (usually the plating or “skin” of the panel). This bonding is achieved by placing one or more layers of high-temperature structural adhesive between each stringer and the skin. Disadvantageously, this consolidation and integration process carried out in autoclave—so called co-bonding process—in order to obtain the stiffened panel, requires at least two polymerization cycles in autoclave (one to cure the single stringers and one to cure the skin at the same time as bonding with the stringers), which involve a substantial expenditure of time and energy. Typically, the co-bonding process also makes use of a cure mould to give the aerodynamic profile to the panel on one side, but only a simple vacuum bag to define the internal surface of the panel, and, because of this, the component has a poor dimensional tolerance on the surfaces intended for assembly with the body substructure. This process, for carbon fibre or glass fibre composite material pre-impregnated with thermoset resin matrix, is typically performed at 180° C. and 6 bar autoclave pressure and under a vacuum bag.

A second manufacturing method for providing stiffened panels is one that provides for the integration of stringers with the skin, both already formed and polymerized, through a mechanical assembly or by drilling the elements in coupling and installing specific connecting members. This second manufacturing method is called “build-up” configuration and is characterized by significant disadvantages in terms of production costs, including: a large number of parts to be manufactured and managed in the production system; a very expensive assembly process, due to the significant number of holes to be drilled and connecting members to be installed, as well as the checks required to verify the absence of a gap or space between the coupled parts; and the additional activities required to make any fillers necessary to fill these gaps, when applicable, during the operation. In addition, the so-called build-up configuration also involves significant weight penalties on the structure, which are poorly tolerated in aeronautical applications, especially due to the increased cost of operating the aircraft, i.e., fuel consumption. The increase in weight for these assemblies derives essentially from the necessary presence of perforations in the coupling areas between the different elements. In effect, the perforations, envisioned as a localized weakening of the component, require a thickening of the affected areas, to safely withstand the design load. In addition, for composite structures, the weight of the connecting members also has a negative impact, since it is greater than that of the portion of material removed.

Finally, in the processing of composite materials, the tooling superimposed on the component as a plug assist, if not properly designed, may compromise the quality of the composite material. In effect, this may interfere, due to the capacity and thermal conductivity of its constituent material, with the optimal parameters of the temperature cycle that activates and finalizes the exothermic process of crosslinking the thermosetting resin, generating a defective material with porosity or inadequate mechanical properties. Moreover, it may alter, due to its configuration, the pressure values transferred to the composite material, acting as a pressure amplifier or attenuator with consequent impact on the quality of the final component in terms of geometric and dimensional variability, and/or internal quality of the laminated solid (porosity, fibre deviations, geometric distortions, or resin build-up).

### SUMMARY OF INVENTION

An object of the present invention is to provide a method for manufacturing an aircraft panel stiffened with open-section composite stringers that overcomes the drawbacks and limitations of applicability of the prior art.

This and other objects are fully achieved according to this invention by a method as defined in the appended independent claim 1.

Advantageous embodiments of the invention are specified in the dependent claims, the content of which is to be understood as an integral and integrating part of the description that follows.

In brief, the invention is based on the idea of providing a method for manufacturing a panel stiffened with open-section stringers in which the components are subjected to a single polymerization process, so-called co-curing, using a tool chain of the mould-plug assist type. In particular, the method according to the invention comprises the steps of:
a) arranging, on a curing surface, a skin made of pre-preg composite material having a first side arranged in contact with the curing surface and a second side arranged opposite said first side;
b) providing a plurality of pre-formed, uncured composite stringers, each of said stringers having an open cross section comprising a web and a base, the web and the base being arranged transverse to each other so that a first base portion protrudes from one end of the web toward a first side relative to the web and a second web portion protrudes from said end of the web toward a second side relative to the web;
wherein said step b) of providing the plurality of stringers comprises, for each stringer, the sub-steps of:
b1) laying-up layers of pre-preg composite material one on the other to form a pair of flat plates by means of a manual or automated process;
b2) trimming said plates according to a predefined design;
b3) arranging each plate on a respective mandrel, in particular a plate on a first mandrel and the other plate on a second mandrel, in such a way that each plate is arranged parallel to an edge of the respective mandrel and partially protrudes from said edge;
b4) having each plate undergo a moulding process, under vacuum or mechanical pressure, according to a specific pressure and temperature cycle, to obtain a formed, uncured semi-stringer having an essentially L-shaped cross section; and
b5) rotating the mandrels and moving them to bring the two semi-stringers in contact and obtain the stringer;
c) arranging said plurality of stringers on said second side of the skin, spaced from each other, each with its base in contact with the second side of the skin;
d) arranging, on each stringer, a respective first mandrel from said first side relative to the web of said stringer in such a manner as to completely cover said first base portion of said stringer, and a respective second mandrel from said second side relative to the web of said stringer in such a manner as to completely cover said second base portion of said stringer; and
e) having the skin and the plurality of stringers undergo a co-curing process in autoclave with vacuum bag, according to a specific pressure and temperature cycle, for curing the non-polymerized components.

According to an advantageous embodiment of the invention, the mandrels used in the co-curing process have a maximum thickness as small as possible, in particular less than 5 mm, preferably less than 3 mm.

According to a particularly advantageous embodiment, such mandrels are made and arranged so as to completely cover the components subjected to the co-curing process, at most except for a head surface of each stringer, said head surface corresponding to the thickness of the web of the respective stringer.

Essentially, according to the preferred embodiment of the invention, the mandrels used in the co-curing process are the same as those used in the preceding forming process for obtaining the stringers and are turned over and placed on the curing surface concurrently with the placement of the respective stringers.

### BRIEF DESCRIPTION OF THE DRAWINGS

Further features and advantages of this invention will be clarified by the detailed description that follows, given purely by way of non-limiting example in reference to the appended drawings, wherein:

FIG. 1 is a side view of a cross section of a panel obtained by a method according to the invention;

FIG. 2 is a side view of a cross section of a stringer and a pair of relative mandrels used in the method according to the invention; and

FIG. 3a through 3e depict different stages of the method according to an embodiment of the invention.

### DETAILED DESCRIPTION

In this context, the term “longitudinal” denotes a direction substantially coincident with or parallel to the main direction of extension of a panel or a stringer, while the term “transverse” denotes a direction substantially perpendicular thereto.

With reference to the figures, a stiffened panel for aircraft as a whole is indicated with 10.

The panel 10 essentially comprises a skin 12 and a plurality of reinforcement stringers 14.

The skin 12 comprises a sequence of pre-preg composite layers, i.e., in non-polymerized or incompletely polymerized materials, preferably made of a composite material with epoxy resin matrix with long carbon fibre reinforcement. The skin 12 may be obtained, for example, by lamination by hand or by automated equipment according to orientations defined by the design of the component to be obtained, or by any other known process of laminating layers of composite material. In the lamination of the skin 12, vacuum bag compaction with or without heat application may be performed in modes known per se.

The skin 12 has a shape that depends on the aerodynamic profile of the component to be made, in a manner known per se. For example, the skin 12 may be in the form of a thin sheet or substantially flat plate, or a slightly concave plate. In any case, the skin 12 has a shape with a substantially two-dimensional extension, i.e., it has two dimensions (width and length) much greater than a third dimension (thickness) and has a first side 12a and a second side 12b, the second side 12b being arranged opposite said first side 12a.

The stringers 14 are provided made of pre-formed but not yet polymerized composite material. The stringers 14 may be obtained by any known composite material processing method. For example, the stringers 14 may be initially flat-laminated, analogous to the skin 12, and subsequently cut or trimmed to a clean profile along one of its edges and subjected to a forming process, according to various operating methods, according to the prior art. For example, the stringers 14 may be formed on a male mould with a membrane and vacuum application, or on a female mould with moulding, with or without heat application, etc. Alternatively, the stringers 14 may be laminated directly on a mould, one layer at a time.

The stringers 14, in their fresh state, i.e., not yet polymerized, may be, then, precisely positioned on the skin 12 by the use of auxiliary tools to support the stringers 14, and tilting systems coordinated with a laminating bed (not shown, known per se) of the skin 12.

In the preferred embodiment of the invention, each stringer 14 has a T-shaped cross section, but it is also possible for the stringers 14 to have a double-T, i.e., H-shaped, or substantially Z-shaped cross section.

In any case, however, the stringers 14 used in the method according to the invention comprise a web 16 and a base 18, which are arranged transversely to each other, preferably orthogonal. The web 16 and the base 18 are arranged such that a first base portion 18a protrudes from an end 20 of the web 16 toward a first side SX of the web 16, and a second base portion 18b protrudes from the same end 20 of the web 16 toward a second side DX of the web 16.

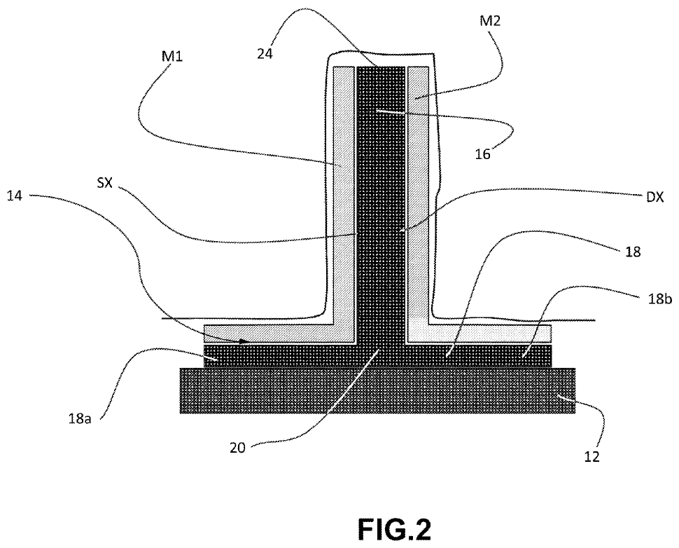

When the cross section of the stringer 14 is T-shaped, the web 16 corresponds to the vertical segment of the T, while the base 18 corresponds to the horizontal segment of the T. As more fully depicted in FIG. 2, the stringer 14 also has a head surface 24, which, in the case of a stringer having a T-shaped cross section, corresponds to the thickness of the web 16 of the stringer 14. When the cross section of the stringers 14 is shaped like a double T or H, the web 16 corresponds to the horizontal segment of the H, while the base 18 corresponds to one of the vertical segments of the H. When the cross section of the stringers 14 is shaped like a Z, the web 16 corresponds to the oblique segment of the Z, while the base 18 corresponds to one of the horizontal segments of the Z. The person skilled in the art will certainly be able to identify a web 16 and a base 18 as defined also in open cross-section stringers 14 with a different shape from those described here by way of example.

Preferably, the composite material of the skin 12 and/or stringers 14 comprises a thermosetting resin, epoxy, or bismaleimide matrix, and a fibre reinforcement phase, preferably carbon fibre, and/or glass fibre and/or Kevlar.

A method for manufacturing a composite panel 10 according to the invention will now be described, starting with the skin 12 and the plurality of stringers 14 as just described.

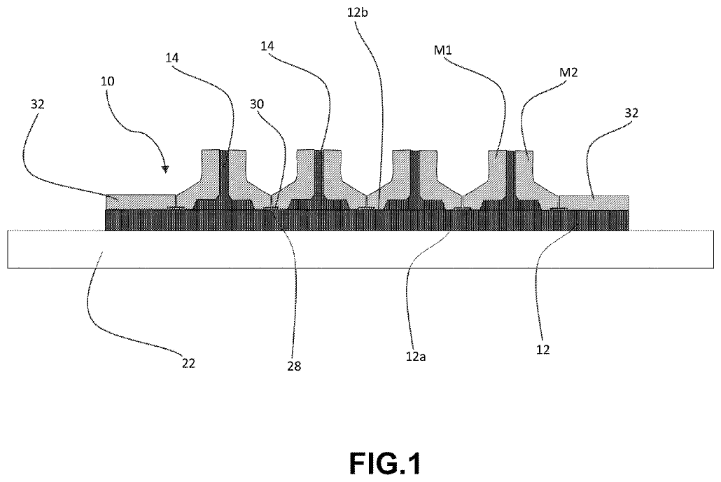

Initially, as shown in FIG. 1, the skin 12 is arranged on a suitable curing surface 22, with the first side 12a arranged in contact with the curing surface 22. Obviously, the curing surface 22 will need to have a shape suitable to support the skin 12, and, thus, a shape substantially at least partially complementary thereto. For example, if the skin 12 is in the form of a sheet, i.e., a substantially flat plate, the curing surface 22 will have a flat bearing surface adapted to support the skin 12.

Then, the plurality of pre-formed, uncured composite stringers 14 are arranged on the second side 12b of the skin 12 of the panel 10. In particular, the stringers 14 are arranged spaced apart from each other, preferably at constant distances from each other, even more preferably arranged parallel to each other. Each stringer 14 is arranged on the second side 12b of the skin 12 so that the respective base 18 is lying in contact with the second side 12b.

The first and second mandrels M1 and M2 are arranged on the stringers 14. The mandrels M1 and M2 have the function of supporting the bag materials to be used in the polymerization process, as well as of distancing and maintaining the stringers 14 in the theoretical positions provided by design, and, in a particularly advantageous embodiment, allowing the transfer of the plurality of stringers 14 (pre-formed and non-polymerized) onto the panel 10.

In particular, a respective first mandrel M1 is arranged on each stringer 14 on the first side SX relative to the web 16 of said stringer 14, and a respective second mandrel M2 is arranged on the second side DX relative to the web 16 of said stringer 14. The first and second mandrels M1 and M2 are each arranged so as to completely cover a base portion 18; in particular the respective first mandrel M1 completely covers the first base portion 18a and the respective second mandrel M2 covers the second base portion 18b of the respective stringer 14.

The shape of each of the first and second mandrels M1 and M2 is preferably so as not only to cover the respective first and second base portion 18a or 18b but also so as to cover completely one half of the stringer 14 on the respective first side SX or second side DX relative to the web 16.

In general, in the prior art, it is quite common to completely cover the stringer (even the head surface), or to use a curing mandrel larger than the stringer in order to leave the head surface free, “exceeding” the web of the stringer, to be able to accommodate, for example, the barrier or sealing material of the resin that fluidifies (i.e. reduces its viscosity) when heated and, under the effect of the pressure exerted on the composite material, tends to move out of the component, depleting it of resin. In this case, the balance of the forces received and transmitted by the mandrel determines an amplification effect of the pressure exerted on the component, which becomes equal to pc=p (1+d/h), where h is the length of the vertical segment, i.e. of the web, of the stringer, pc is the pressure exerted on the component, p is the pressure theoretically applied by the autoclave and d is the free space on the head surface of the stringer, i.e. the “excess” height of the mandrel relative to the web of the stringer. The percentage of increase of the pressure applied to the composite (equal to d/h) relative to the theoretical P (typically 7 bar, in autoclave polymerization processes) may be very high, resulting in an excessive loss of resin with consequent compromise of the quality of the laminated solid and damage to the component due to the presence of porosity, excessive thinning of the web, or non-uniform distribution of the web thickness. In order to be able to overcome this disadvantage, in an embodiment of the method according to the invention, each first and second mandrel M1 and M2 is arranged on a respective stringer 14 in such a way that the surface of said stringer 14 is completely covered, preferably at most except for the respective head surface 24 of the stringer 14, i.e. in such a way that each first mandrel M1 or second mandrel M2 does not “exceed in height” the web of the respective stringer 14 (this configuration is shown in FIG. 2, from which the preferable dimensional relationship between the web 16 of the stringer 14 and the first and second mandrels M1 and M2 is clear). In this configuration of the first and second mandrels M1 and M2, the sealing of the resin on the surface 24 of the stringer 14 is achieved with the same materials as the curing bag due to the mechanical crushing exerted by the pressure of the autoclave.

According to a preferred embodiment of the invention, each first mandrel M1 and each second mandrel M2 is made to have a maximum thickness of 5 mm, even more preferably a maximum thickness of 3 mm. As may be clearly and unambiguously inferred from FIG. 2, in the case of mandrels having a substantially folded sheet shape, i.e., a folded plate shape (e.g., as in FIG. 2, with a cross section in the shape of a letter L) the “maximum thickness” of the first mandrel M1 or the second mandrel M2 means the transverse thickness of the section, i.e., the thickness transversely visible in the section of FIG. 2.

Preferably, each first mandrel M1 and each second mandrel M2 has a cross-sectional shape defined purely as an “offset” from the shape of the profile of the respective stringer 14.

According to a preferred embodiment of the invention, at least one of the curing surface 22 and/or each of the mandrels M1 and M2 is made of a metallic material, preferably aluminium, or steel, or invar-36 alloy, or a composite material, in any case with a low thermal expansion coefficient.

The dimensional values and/or material requirements related to the first and second mandrels M1 and M2 that have been presented as particularly preferable—in contrast to that which has already been disclosed in the prior art—allow for the temperature and pressure transfer to the composite material to be optimized during the polymerization thereof, thus enabling the manufacture of a complex component free of defects. Indeed, in the prior art, the radial zone of the mandrel (i.e. the zone that is positioned adjacent to the “curve” between the web and the base of the stringer) and that which is in charge of transferring the pressure in the stringer node, i.e. in the junction point between web and base, is a critical zone, which is located in a pressure shadow, so that the composite material in this zone may present porosity, voids, excess resin, fibre deviations, or other morphological deformations. Indeed, this zone is in the pressure shadow because, applying the principle of force balance, due to the smaller extension of the mandrel radius from the side in contact with the bag material relative to its radius, which is in contact with the stringer, it happens that the pressure applied in the radial zone of the stringer by the mandrel is lower than the theoretical one applied outside the mandrel by a factor that depends on the ratio between mandrel thickness and external curvature radius of the mandrel in the radial zone. In the method according to one embodiment, it has been determined through research, simulations, and laboratory testing that the best balance between the requirement for mandrel strength and the requirement for the lowest possible thickness (necessary to reduce the pressure deficit in the stringer node) is, as described, achieved with a maximum thickness of the first or second mandrel M1 or M2 of less than 5 mm, and, preferably, less than 3 mm.

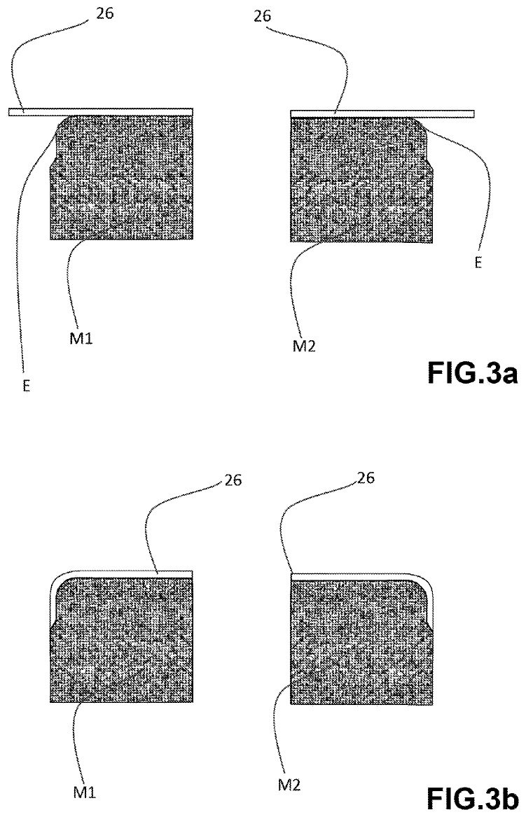

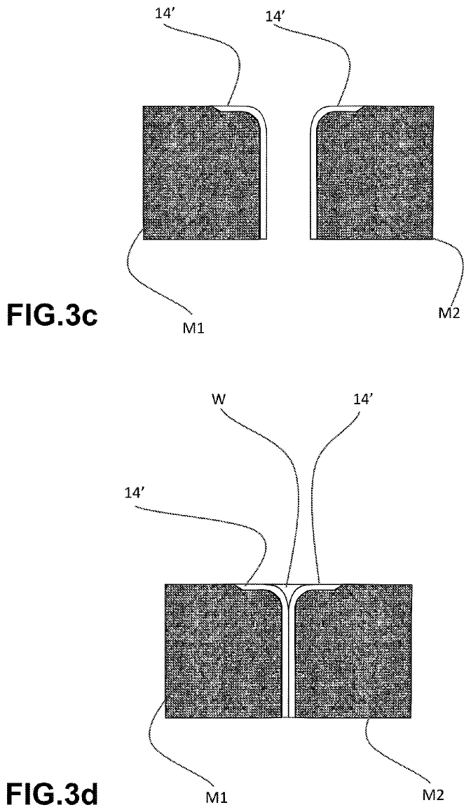

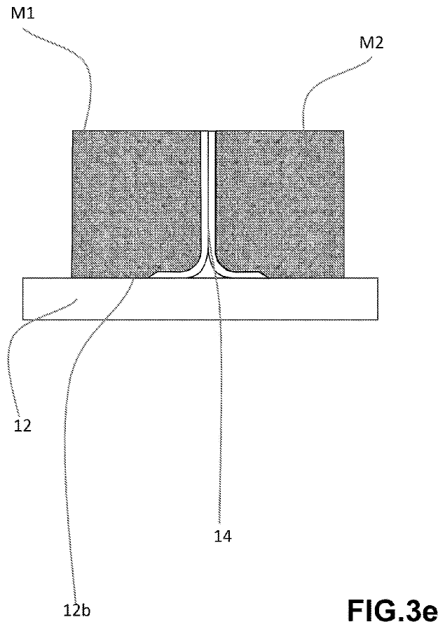

According to the invention, each stringer 14 is made by a method that makes use of the same first mandrel M1 and second mandrel M2 used in the step e) of co-curing or co-polymerization that will be described below. In particular, this method involves the following steps:
b1) laying-up layers of pre-preg composite material one on the other to form a pair of identical flat plates 26 by means of a manual or automated process;
b2) trimming said plates 26 according to a predefined design;
b3) arranging each plate 26 on a respective mandrel, in particular a plate 26 on a first mandrel M1 and the other plate 26 on a second mandrel M2, in such a way that each plate 26 is arranged parallel to an edge E of the respective mandrel M1, M2 and partially protrudes therefrom (the plate 26 thus obtained is arranged as shown in FIG. 3a);
b4) having each plate 26 undergo a moulding process, under vacuum or mechanical pressure according to a specific pressure and temperature cycle, to obtain a formed, uncured semi-stringer 14′ having an essentially L-shaped cross section (see FIG. 3b); and
b5) rotating the first mandrel M1 and the second mandrel M2 (FIG. 3c) and moving them to bring the two semi-stringers 14′ (FIG. 3d) in contact and obtain the stringer 14.

Once the two semi-stringers 14′ are brought into contact, a filler insert W, typically having a rod shape with a cuspidal wedge cross section, is preferably inserted to strengthen the connection between the two semi-stringers 14′ (see FIG. 3d).

At this point, the stringers 14 and their respective first mandrels M1 and second mandrels M2 may be turned over and positioned on the second side 12b of the skin 12 by manual action or automated handling mechanisms, in a manner known per se (see FIG. 3e). This operation may be precisely coordinated by means of suitable metallic engagement systems arranged both on the curing surface 22 and on the first and second mandrels M1 and M2. In this manner, the step of arranging the plurality of stringers 14 on the second side 12b of the skin 12 is, advantageously, carried out with each stringer 14 already arranged between the respective first mandrel M1 and the respective second mandrel M2.

Preferably, the method according to the invention comprises the step of arranging, for each pair of first mandrel M1 and second mandrel M2 between which no stringer 14 is arranged, a respective plurality of secondary curing flaps 28 between the first mandrel M1 arranged on a stringer 14 on the first side SX relative to the web 16 of said stringer 14, and the second mandrel M2 arranged on a subsequent, i.e., adjacent, stringer 14 on the second side DX relative to the web 16 of said adjacent stringer 14. Such secondary curing flaps 28 are preferably made of spring steel, or a pre-cured or pre-polymerized composite material, and have a maximum thickness between about 0.1 mm and about 0.2 mm. Clearly, in such a case, each first mandrel M1 and each second mandrel M2 has a respective seat 30 for housing said secondary curing flaps 28 of at least partially complementary shape.

Preferably, the method according to the invention further comprises the step of arranging on the second side 12b of the skin 12 a respective curing plate 32 on each skin portion 12 that is not covered by either a stringer 14 or a first or second mandrel M1 or M2, so as to provide the complete coverage of the second side 12b of the skin 12 to ensure that the shape of the stringers 14 and the skin 12 is maintained during the curing process. The caul plates 32 are preferably made of carbon fibre or metallic material, sufficiently rigid, and of equal, or nearly equal, or comparable thickness to that of the edges of the first and second mandrels M1 or M2 with which they are in contact. In areas where the edges of mandrels M1 and M2 of two successive stringers 14 are side by side and juxtaposed with each other, a gap of up to 1 mm of relative distance may be accepted. The same gap is applicable where the edges of the caul plates 32 are juxtaposed with the edges of the mandrel M1 or M2.

In one embodiment, the caul plates 32 are, for example, formed of two successive layers of composite material, or of 0.5-1 mm aluminium layers.

At this point, the method according to the invention is completed with the co-curing step, i.e., co-polymerization, which has the skin 12 and the plurality of stringers 14 undergo a co-curing process in autoclave with a vacuum bag, according to a specific temperature and pressure cycle, for jointly curing the skin 12 and the plurality of stringers 14.

In particular, first dressing with the bag materials typical of the vacuum bag autoclave polymerization process, such as, for example, high temperature nylon film, nylon or polyester surface ventilation fabric, high temperature separator film, is carried out. These materials may be arranged manually on the assembly comprising the skin 12, the plurality of stringers 14, and the first and second mandrels M1 and M2 on top of each other, obtaining, by means of taping and sealing, an extension that entirely surrounds the assembly. After the dressing is complete, a vacuum may be applied to the outermost layer of the curing bag to ensure that the bag materials fit the surfaces, preventing wrinkling and bridging of the materials.

Advantageously, a pair of external curing tools may also be arranged on the side of the skin 12 to lock its position and ensure that its shape is maintained during the co-curing method. The process is completed by sealing the ends of the curing bags to each other and to the respective sides of the curing surfaces 22.

After having applied the full vacuum to the curing bags and having performed the appropriate leakage checks, the assembly comprising the skin 12, the plurality of stringers 14, and the respective first and second mandrels M1 and M2 is subjected to the polymerization process. Said autoclave polymerization process is known per se and provides for the application of a specific temperature and pressure cycle and will not be described further. Typically, the autoclave polymerization process may comprise at least one cycle at a temperature of about 180° C.+/−5° C. and a pressure of about 5.9-6.8 bar.

After the polymerization process is complete, the unwrapping process may be performed, i.e., removal of the curing bags, removal of the first and second mandrels M1 and M2, as well as any caul plates 32 or secondary curing flaps 28.

As is evident from the description provided above, by means of a manufacturing method according to the invention, several advantages may be obtained.

By virtue of such a method it is possible to reduce, relative to the so-called “build-up” configuration: the production costs, by virtue of the lower number of parts to be manufactured and managed in the production system; the number of holes and the relative connecting members to be installed, thus reducing the assembly times and costs and the supply of drilling bits and connecting members, which are typically very expensive; the number of checks to be carried out during the assembly phase to test the connecting members and to verify the absence of any play between the coupled parts; and the weight of the structure, by virtue of the reduced number of connecting members required and the elimination of local thickening in the drilling areas necessary to safely support the design loads.

In addition, by virtue of the use of a co-curing process in place of the conventional co-bonding process, it is possible to polymerize and consolidate, by gluing together, the stringers and the skin of the panel through a single autoclave cycle, at the same temperature and pressure, and without needing to resort to layers of structural adhesives to be interposed between the coupled elements.

In addition, the simultaneous consolidation of the panel and the stringers requires, in addition to the vacuum bag, the presence of an additional rigid mould to cover the panel completely, which allows for a very precise internal surface with a strong finish to be provided. The co-bonding process, on the other hand, having only the bag on the inside of the panel, gives the part a poorer dimensional tolerance precisely on the surfaces intended for assembly with the body substructure.

In addition, when the tooling of the mould-plug assist type meets the dimensional and shape requirements of the preferred embodiment of the invention, the invention allows for an excellent internal quality of the solid laminate even in the critical areas of the stringers, and a qualitative increase on the entire inner surface of the panel, i.e. an excellent surface finish and the absence of irregularities as well as a higher geometric precision of the component (reduced variability of panel thickness and position of the stringers), making the process more robust from the dimensional point of view. These improvements have an important positive impact in the assembly steps of the stiffened panels with the other structural components that make up the final body of the aircraft component, such as ribs and stringers: the improvement of the quality of the surfaces and the reduced variability of the thicknesses allow, first of all, for the designer to reduce the number of shims in the design (fillers provided to compensate for the geometric variability of the coupled parts by managing the risk of interference) and at the same time, in the final assembly line, the activities of constructing shims in line (structural fillers to be made on site and to be interposed between the mechanically coupled parts when their surfaces are not in contact with each other) are reduced/simplified. This activity turns out to be very expensive in terms of work-hours; moreover, it is not fully predictable, with consequent impacts on the productive flow and on the production cost.

In addition, the method of the patent application ensures a reduction in recurring production costs if compared to a traditional co-bonding process that involves bonding the already polymerized or pre-cured stringers to the fresh panel. Key industrial benefits to be noted include:
lower consumption of the auxiliary production materials that is obtained by switching from a co-bonding process to a co-curing process;
reduction in work-hours required for each panel;
lower costs due to the use of industrial equipment (fewer autoclave cycles, reduced machine setup time for NDI checks and trimming);
reduced environmental impact due to less use of auxiliary production materials and reduced use of production facilities.

Without prejudice to the principle of the invention, the embodiments and the details of construction may be widely varied relative to that which has been described and illustrated purely by way of non-limiting example, without thereby departing from the scope of the invention defined in the appended claims.

1. A method for manufacturing a stiffened panel for an aircraft, the method comprising the steps of:
a) arranging, on a curing surface, a skin of a pre-preg composite material, having a first side arranged in contact with the curing surface and a second side arranged opposed to said first side;
b) providing a plurality of pre-formed stringers of an uncured composite material, each of said pre-formed stringers having an open cross section comprising a web and a base, the web and the base being arranged transverse to each other so that a first base portion protrudes from an end of the web towards a first side relative to the web and a second base portion protrudes from said end of the web towards a second side relative to the web;
wherein said step b) of providing the plurality of pre-formed stringers comprises, for each stringer of the plurality of pre-formed stringers:
b1) laying-up layers of the pre-preg composite material one on the other to form a pair of flat plates by a manual or automated process;
b2) trimming said pair of flat plates according to a predefined design;
b3) arranging each plate of the pair of flat plates on a respective mandrel, namely one plate of the pair of flat plates on a first mandrel and the other plate of the pair of flat plates on a second mandrel, in such a way that each plate is arranged parallel to an edge of the respective mandrel and partially protrudes from said edge;
b4) having each plate undergo a moulding process, under vacuum or mechanical pressure, according to a specific pressure and temperature cycle, to obtain a formed, uncured semi-stringer having an L shaped cross section; and
b5) rotating the first and second mandrels and moving the first and second mandrels to bring two semi-stringers in contact and obtain the stringer;
c) arranging the plurality of pre-formed stringers on the second side of the skin, spaced from each other, each stringer with its base in contact with the second side of the skin;
d) arranging, on each stringer, the respective first mandrel from said first side relative to the web of said stringer to completely cover said first base portion of said stringer, and the respective second mandrel from said second side relative to the web of said stringer to completely cover said second base portion of said stringer; and
e) having the skin and the plurality of pre-formed stringers undergo a co-curing process in autoclave with vacuum bag, according to a specific pressure and temperature cycle, for curing non-polymerized components.

2. The method of claim 1, further comprising the step of:
d1) before step e), arranging on the second side of the skin a respective caul plate on each portion of the second side of the skin that is not covered by a stringer nor by a first or second mandrel to ensure complete covering of the second side of the skin.

3. The method of claim 1, wherein the skin is obtained by manual or automated lay-up of successive layers of the pre-preg composite material.

4. The method of claim 1, wherein the step c) of arranging the plurality of pre-formed stringers on the second side of the skin is performed with each stringer already arranged between the respective first mandrel and the respective second mandrel and secured to the respective first and second mandrels.

5. The method of claim 1, wherein each first mandrel and each second mandrel have a maximum thickness of 5 mm.

6. The method of claim 1, wherein each first mandrel is configured to completely cover one half of a stringer from the first side relative to the web, and wherein each second mandrel is configured to completely cover the other half of said stringer from the second side relative to the web.

7. The method of claim 2, further comprising the step of:
d2) before step e), arranging, for each pair of first mandrel and second mandrel between which no stringer is arranged, a respective plurality of secondary curing flaps between the first mandrel arranged on a stringer on the first side relative to the web and the second mandrel arranged on an adjacent stringer on the second side relative to the web, wherein said secondary curing flaps are made in spring steel or in a pre-cured composite material, and have a maximum thickness comprised between about 0.1 mm and about 0.2 mm.

8. The method of claim 7, wherein each of said first mandrel and second mandrel has a respective seat for accommodating said secondary curing flaps.

9. The method of claim 1, wherein the composite material of at least one among the skin and the plurality of pre-formed stringers comprises a matrix in a thermoset bismaleimide or epoxy resin and a carbon and/or glass and/or Kevlar fibre reinforcement.

10. The method of claim 1, wherein each of the pre-formed stringers has a T-shaped cross section, a double-T or H-shaped cross section, or a Z-shaped cross section.

11. The method of claim 1, wherein at least one among the curing surface, the first mandrel and the second mandrel is made of a metallic material, steel, INVAR 36, or of a composite material.

12. The method of claim 1, wherein, during step e) of co-curing in autoclave with vacuum bag, the second side of the skin and a surface of each stringer are completely covered, at most except from a respective head surface of each stringer corresponding to a thickness of the respective web of each stringer.

13. A stiffened panel comprising a skin and a plurality of stringers obtained by the method of claim 1.

14. The method of claim 1, wherein each first mandrel and each second mandrel have a maximum thickness of 3 mm.

15. The method of claim 11, wherein the metallic material is aluminium.
